(19) United States
(12) Patent Application Publication
(10) Pub. No.: US 2005/0174041 A1
(43) Pub. Date: Aug. 11, 2005

(54) Display device with improved light emitting diode and a method of manufacturing the improved light emitting diode

(75) Inventor: Chun-Huai Li, Pingtung County (TW)

Correspondence Address: ARENT FOX PLLC, 1050 CONNECTICUT AVENUE, N.W., SUITE 400, WASHINGTON, DC, 20036, US

(73) Assignee: AU OPTRONICS

(21) Appl. No.: 10/771,329

(22) Filed: Feb. 5, 2004

(51) Int. Cl. H05B 33/00

(52) U.S. Cl. 313/500; 313/506

(57) ABSTRACT

A display device having a substrate layer and a dielectric layer configured to have a plurality of arcuate surfaces disposed at predetermined locations adjacent to one face of the substrate layer. In addition, the display device includes a diode disposed adjacent to the substrate layer and the dielectric layer. The diode is constructed to correspond to one surface face formed by the substrate layer and the dielectric layer.

### BACKGROUND OF THE INVENTION

1. Field of Invention

The present invention relates to a display device having improved light emitting diode(s) and a method of manufacturing the same. In particular, the present invention is directed to a flat panel display device employing one of more improved organic light emitting diode(s) (“OLED”), such that the improved OLED provides an increase in brightness and an increase in durability. Moreover, the present invention is directed to a method of manufacturing the improved OLED.

2. Related Art

FIG. 1 illustrates a cross-sectional view showing some components of a display panel 10 in the related art having a conventional OLED 11 disposed therein. The substantially complete display panel 10 includes a glass layer 12 and a dielectric layer 13 disposed thereon. In addition, the display device 10 includes a conventional rectangular shaped OLED 11 disposed on the dielectric layer 13. The conventional OLED 11 has a transparent first electrode layer 14 such as an anode, an emitting layer 15, and a second electrode layer 16 such as a cathode.

According to FIG. 1, each layer of the display panel 10 is in a linear stripe configuration. As such, the size of the emitting area over the overall sub-pixel size with respect to the display device 10 is very small. The ratio with respect to the size of the emitting area over the overall sub-pixel size is also referred to as the open ratio. Accordingly, the open ratio of the display device 10 is small, and therefore the brightness and the durability of the display device 10 is low. Thus, there is a need for a display device having OLED(s) configured to have a large open ratio such that the display device has an increased brightness and increased durability.

### SUMMARY OF THE INVENTION

One example of the present invention provides a display device having a substrate layer and a dielectric layer configured to have a plurality of arcuate surfaces disposed at predetermined locations adjacent to one face of the substrate layer. In addition, the display device includes a diode disposed adjacent to the substrate layer and the dielectric layer. The diode is constructed to correspond to one surface face formed by the substrate layer and the dielectric layer.

### DESCRIPTION OF THE DRAWINGS

The accompanying drawings, which are include to provide a further understanding of the present invention and are incorporated in and constitute a part of this specification, illustrate examples of the present invention and together with the description serve to explain the principles of the present invention.

In the drawings:

FIG. 1 illustrates a cross-sectional view showing some components of a display panel in the related art having a conventional OLED disposed therein;

FIG. 2 illustrates a cross-sectional view showing one example of various components of a display device;

FIG. 3 illustrates a cross-sectional view showing another example of the various components of a display device;

FIG. 4 illustrates a cross-sectional view of another example of various components of a pixel within a display device;

FIG. 5 illustrates a cross-section view of one example of a “top light emission” pixel within a display device;

FIG. 6 illustrates a cross-section view of yet another example of a “top light emission” pixel of a display device;

FIG. 7(A) through 7(D) illustrate some examples of arcuate masses or “bumps” disposed at predetermined locations within a display device;

FIG. 8(A) provides a charting illustrating the performance with respect to the brightness of the OLED based on the examples provided in FIGS. 7(A) through 7(D); and

FIG. 8(B) provides a chart illustrates the performance of the various arcuate “bumps” based on the relationship between the amount of current supplied and the brightness of the various shapes of the “bumps” as illustrated in FIGS. 7(A) through 7(D).

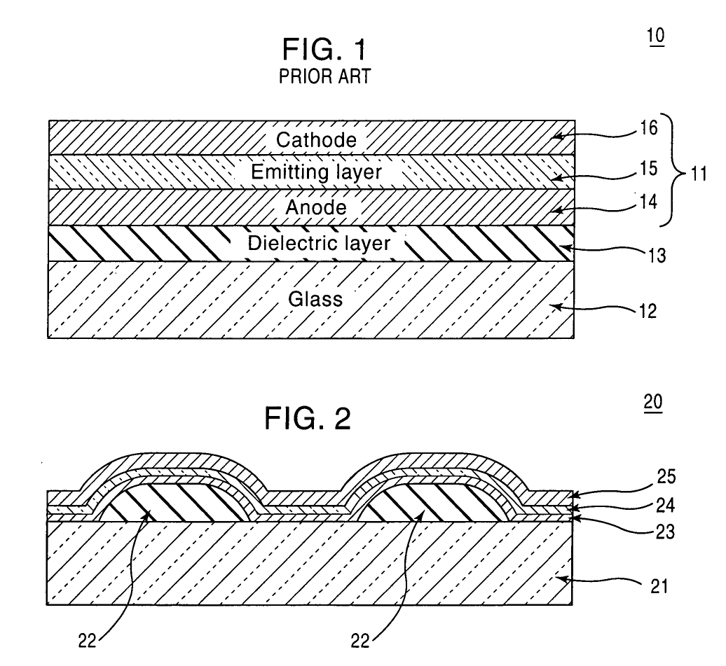

### DETAILED DESCRIPTION OF THE EXEMPLARY EMBODIMENTS

Reference will now be made in detail to the exemplary embodiments of the present invention, examples of which are illustrated in the accompanying drawings.

The present invention relates to a flat panel display device employing one of more improved organic light emitting diode(s) (“OLED”), such that the improved OLED structure is configured to provides an increase in brightness and an increase in durability. Moreover, the present invention is directed to a method of manufacturing the improved OLED structure.

FIG. 2 illustrates a cross-sectional view showing various components of a display device 20 such as a flat panel display device or an active matrix electroluminescent device. The various components of the display device 20 include a first transparent layer 21 such as a transparent substrate. For instance, the first transparent layer 21 can be glass or plastic. The various components of the display device 20 also include one or more arcuate transparent mass(es) 22 disposed at predetermined locations on the first transparent layer 21 such that the arcuate masses protrude away from the first transparent layer 21. For example, the one or more arcuate transparent mass(es) can be transparent dielectric arcuate “bumps” wherein each “bump” includes an arcuate convex surface, and the “bumps” are deposited at predetermined locations on the first transparent layer 21. The one or more arcuate transparent masses are formed by first depositing a layer of transparent material such as a layer of dielectric material on the first transparent layer 21. Subsequently, the layer of transparent material is etched at predetermined locations of the transparent material such that the transparent material at the predetermined locations is etched away resulting in one or more arcuate transparent masses that are discrete and separated from one another on the first transparent layer 21. Each transparent mass includes an arcuate convex surface.

In addition, FIG. 2 shows a first electrode layer 23 such as an anode layer deposited on the one or more arcuate transparent masses 22 and on the transparent layer 21. For instance, the first electrode layer 23 is deposited above the arcuate dielectric bumps and above the glass substrate such that the first electrode layer 23 covers the contours and/or the surface area formed by the arcuate dielectric bumps and the glass substrate.

Moreover, the various components of the display device 20 include an emitting layer 24 and a second electrode layer 25 deposited above the first electrode layer 23. The emitting layer 4 can, for example, be an electroluminescent organic layer; and the second electrode layer 25 can, also for example, be a cathode layer. Although not shown in FIG. 2, the emitting layer 24 can comprise of at least an electron transport layer, an emitting layer, a hole transport layer, and a hole injection layer.

As shown in FIG. 2, the emitting layer 24 is deposited on the first electrode layer 23 and the second electrode layer 25 is deposited on the emitting layer 24, such that the emitting layer 24 and the second electrode layer 25 have substantially the same contours as the first electrode layer 23. According to the example shown in FIG. 2, the OLED of the present invention comprises of at least the three layers of the first electrode layer 23, the emitting layer 24, and the second electrode layer 25.

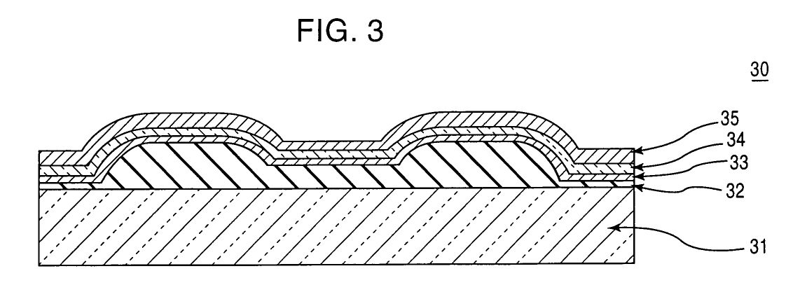

FIG. 3 illustrates a cross-sectional view showing another example of the various components of a display device 30 such as a flat panel display device or an active matrix electroluminescent device. The various components of the display device 30 include a first transparent layer 31, and a second transparent layer 32 such as a dielectric layer. In addition, the various components of FIG. 3 include a first electrode layer 33, an emitting layer 34, and a second electrode layer 35 deposited above the second transparent layer 32 such that the first electrode layer 33, the emitting layer 34 and the second electrode layer 35 substantially conform to the top face of the second transparent layer 32. The OLED of the present example comprises of at least the first electrode layer 33, the emitting layer 34 and the second electrode layer 35.

According to the example shown in FIG. 3, the second transparent layer 32 is one continuous layer with one or more arcuate protrusions also referred to as “bumps”. The second transparent layer 32 is formed by first depositing a layer of transparent material such as a layer of dielectric material on the first transparent layer. Subsequently, the layer of transparent material is etched at predetermined locations of the transparent material such that the transparent material at these predetermined locations is etched away resulting one continuous second transparent layer 32 on the first transparent layer 21 having linear flat surfaces and having arcuate protruding surfaces.

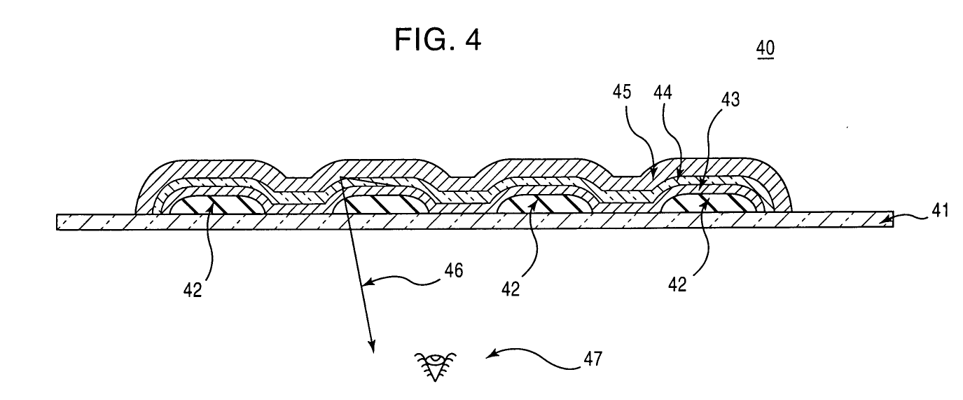

FIG. 4 illustrates a cross-sectional view of one example of various components of a pixel within a display device 40. The various components of the pixel within the display device 40 include a first transparent layer 41 such as a transparent substrate and one or more arcuate transparent mass(es) 42 disposed at predetermined locations on the first transparent layer 41 such that the arcuate masses protrude away from the first transparent layer 41. For example, the one or more arcuate transparent mass(es) can be transparent dielectric arcuate “bumps” deposited at predetermined locations on the first transparent layer 41. Similar to the example shown in FIG. 2, the one or more arcuate transparent masses are formed by first depositing a layer of transparent material such as a layer of dielectric material on the first transparent layer 41. Subsequently, the layer of transparent material is etched at predetermined locations of the transparent material such that the transparent material at the predetermined locations is etched away resulting in one or more arcuate transparent masses that are discrete and separated from one another on the first transparent layer 41.

In addition, FIG. 4 shows a first electrode layer 43 such as an anode layer deposited on the one or more arcuate transparent masses 42 and on the transparent layer 41, an emitting layer 44 and a second electrode layer 45 deposited above the first electrode layer 43. The OLED of the present example comprises of at least the first electrode layer 43, the emitting layer 44 and the second electrode layer 45.

As shown in FIG. 4, the three layers 43, 44 and 45 comprising the OLED is deposited such that the layers 43, 44 and 45 conform to the top surface face formed by the first transparent layer 41 and the one or more transparent arcuate masses 42.

Furthermore, FIG. 4 illustrates one example of various components of a pixel whereby the emission of light is in the direction 46 toward the viewer 47. As such, FIG. 4 shows an OLED comprising of the first electrode layer 43, the emitting layer 44 and the second electrode layer 45 such that the first electrode layer 43 and the emitting layer 44 are made of a transparent material for the traversal of light, and such that the second electrode layer 45 is made of a light reflective material, such as aluminum or tungsten for reflecting light towards the viewer 47. For example, the second electrode layer 45 can be a cathode layer made of a high light reflective material so that any light originating at the OLED is reflected off the high reflective cathode layer toward the view 47. This example of light emission is also referred to as “bottom light emission” of a pixel.

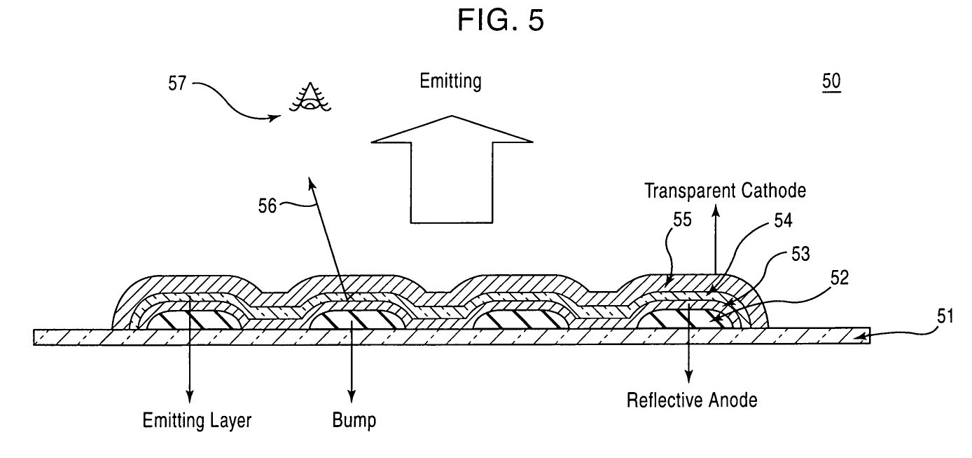

In contrast, FIG. 5 shows a cross-section view of one example of a “top light emission” pixel within a display device 50. In particular, FIG. 5 shows one example of various components of the pixel within the display device 50 including a first layer 51 which can be transparent layer or an opaque layer. In addition, the various components of FIG. 5 include one or more arcuate mass(es) 52 disposed at predetermined locations on the first layer 51 such that the arcuate masses protrude away from the first layer 51. The arcuate masses 53 can also be made of a transparent material or an opaque material. Similar to the example shown in FIG. 2, the one or more arcuate masses 53 are formed by first depositing a layer of either transparent or opaque material on the first layer 51. Subsequently, the layer of either transparent or opaque is etched at predetermined locations such that the transparent or the opaque material at the predetermined locations is etched away resulting in one or more arcuate masses that are discrete and separated from one another on the first layer 51.

In addition, FIG. 5 shows a first electrode layer 53 such as an anode layer deposited on the one or more arcuate masses 52 and on the first layer 51, an emitting layer 54 and a second electrode layer 55 deposited above the first electrode layer 53. The OLED of the present example comprises of at least the first electrode layer 53, the emitting layer 54 and the second electrode layer 55.

As mentioned above, FIG. 5 illustrates one example of a “top light emission” pixel whereby the emission of light is in the direction 56 toward the viewer 57. As such, FIG. 5 shows an OLED comprising of the first electrode layer 53, the emitting layer 54 and the second electrode layer 55 such that the emitting layer 54 and the second electrode layer 55 are made of a transparent material for the traversal of light, and such that the first electrode layer 53 is made of a light reflective material, such as aluminum or tungsten for reflecting light towards the viewer 57. For example, the first electrode layer 53 can be an anode layer made of a high light reflective material so that any light originating at the OLED is reflected off the high reflective anode layer toward the view 47.

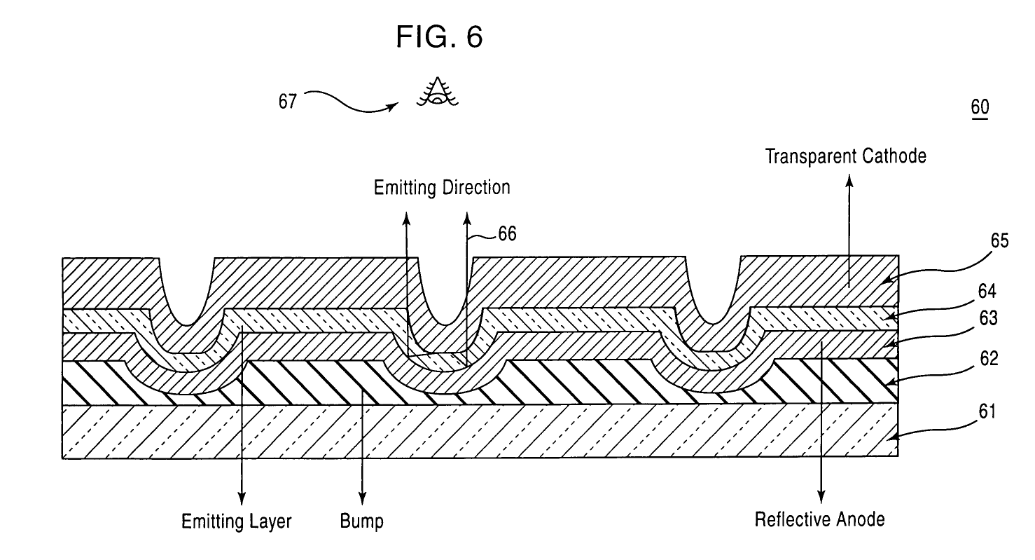

FIG. 6 further shows a cross-section view of yet another example of a “top light emission” pixel of a display device 60. In particular, FIG. 6 shows one example of various components of the pixel within the display device 60 including a first layer 61 which can be constructed of either a transparent material or an opaque material. In addition, FIG. 6 shows a second layer 62 such as a dielectric layer deposited on the top surface of the first layer 61. The second layer 62 can also be constructed of either a transparent material or an opaque material. According to the example of FIG. 6, the second layer 62 contains one or more arcuate concave recess(es) positioned at predetermined locations of the second layer 62.

The one or more arcuate concave recesses are formed by first depositing a layer of transparent or opaque material such as a layer of dielectric material on the first layer 61. Subsequently, the layer of transparent or opaque material is etched at predetermined locations such that the transparent or opaque material at predetermined locations is etched away resulting in one or more arcuate concave recesses.

In addition, FIG. 6 shows a first electrode layer 63 such as an anode layer deposited on the second layer 62 having the arcuate concave recesses. For instance, the first electrode layer 63 is deposited above the second layer 63 such that the first electrode layer 63 covers the contours and/or the surface area formed by the second layer 62.

Moreover, the various components of the display device 60 include an emitting layer 64 and a second electrode layer 65 deposited above the first electrode layer 63. The emitting layer 64 can, for example, be an electroluminescent organic layer; and the second electrode layer 65 can, for example, be a cathode layer. Although not shown in FIG. 6, the emitting layer 64 can comprise of at least an electron transport layer, an emitting layer, a hole transport layer, and a hole injection layer.

Also shown in FIG. 6, the emitting layer 64 is deposited on the first electrode layer 63 and the second electrode layer 65 is deposited on the emitting layer 24, such that the emitting layer 64 and the second electrode layer 25 have substantially the same contours as the first electrode layer 63. In essence, the emitting layer 64 and the second electrode layer 65 also include one or more arcuate concave recesses formed above the arcuate concave recesses of the first electrode layer 63. According to the example shown in FIG. 6, the OLED of the present example comprises of at least the three layers of the first electrode layer 63, the emitting layer 64, and the second electrode layer 65.

As mentioned above, FIG. 6 illustrates one example of a “top light emission” pixel. As such, the emission of light according to this example is in direction 66 toward the viewer 67. Thus, FIG. 6 shows an OLED comprising of the first electrode layer 63, the emitting layer 64 and the second electrode layer 65 such that the emitting layer 64 and the second electrode layer 65 are made of a transparent material for the traversal of light, and such that the first electrode layer 63 is made of a light reflective material, such as aluminum or tungsten for reflecting light towards the viewer 67. For example, the first electrode layer 63 can be an anode layer made of a high light reflective material so that any light originating at the OLED is reflected off the high reflective anode layer toward the view 67.

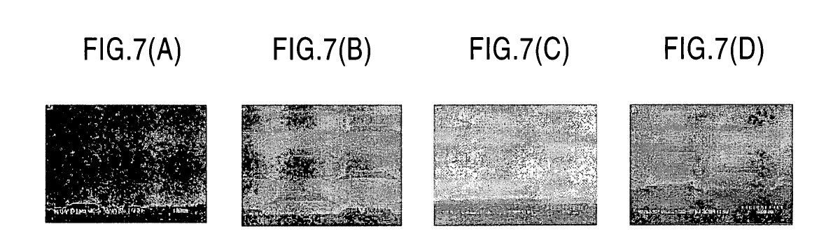

FIGS. 7(A) through 7(D) illustrate some examples of arcuate masses or “bumps” disposed at predetermined locations within a display device. According to the present invention, an increase in the emitting area size will decrease the current density of the display device. Therefore, the brightness and the durability of the OLED with the display device will thereby increase.

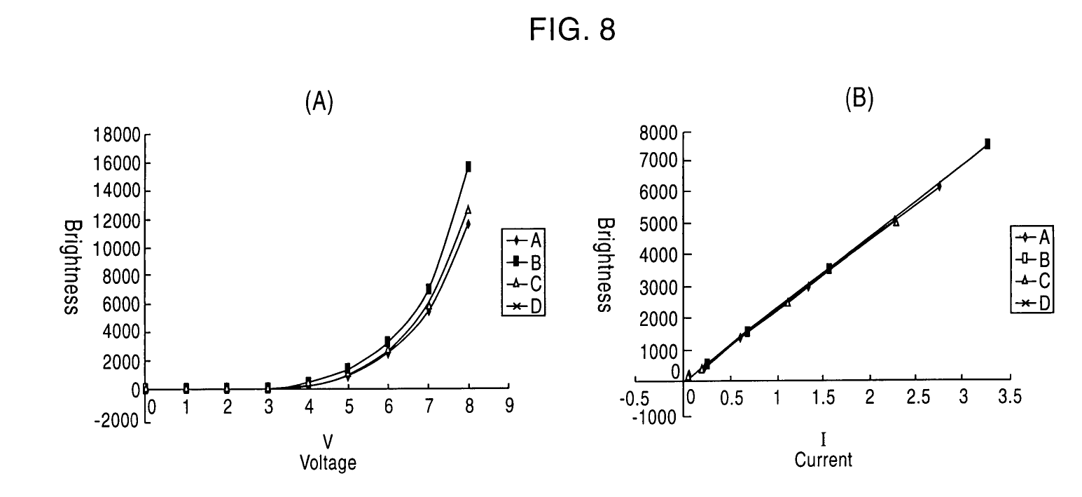

FIG. 8(A) shows a charting illustrating the performance with respect to the brightness of the OLED based on the examples provided in FIGS. 7(A) through 7(D). In particular, FIG. 8(A) illustrates the performance of the various arcuate “bumps” based on the relationship between the amount of voltage supplied and the brightness of the various shapes of the “bumps”. Furthermore, FIG. 8(B) provides a chart illustrates the performance of the various arcuate “bumps” based on the relationship between the amount of current supplied and the brightness of the various shapes of the “bumps” as illustrated in FIGS. 7(A) through 7(D).

It will be apparent to those skilled in the art that various modifications and variations can be made to a flat panel display device employing one of more improved organic light emitting diode(s) (“OLED”) of the present invention without departing from the spirit or scope of the invention. Thus, it is intended that the present invention covers the modifications and variations of this invention provided they come within the scope of the appended claims and their equivalents.

1. A display device comprising:
a substrate layer;
a dielectric layer configured to have a plurality of arcuate surfaces disposed at predetermined locations adjacent to one face of the substrate layer; and
a diode disposed adjacent to the substrate layer and the dielectric layer, wherein the diode is constructed to correspond to one surface face formed by the substrate layer and the dielectric layer.

2. The display device of claim 1, wherein the diode comprises:
a first electrode layer deposited adjacent to the substrate layer and the dielectric layer;
an emitting layer deposited adjacent to the first electrode layer; and
a second electrode layer deposited adjacent to the emitting layer.

3. The display device of claim 2, wherein the first electrode layer comprises an anode, and wherein the second electrode comprises a cathode.

4. The display device of claim 1, wherein the diode comprises an organic light emitting diode.

5. The display device of claim 1, wherein the dielectric layer is configured to have a plurality of arcuate convex surfaces disposed at predetermined locations adjacent to the one face of the substrate layer.

6. The display device of claim 5, wherein the dielectric layer is configured to have a plurality of arcuate protrusions disposed at predetermined locations adjacent to the one face of the substrate layer.

7. The display device of claim 6, wherein the dielectric layer is configured to have the plurality of arcuate protrusions connected together through connectors disposed at predetermined locations adjacent to the one face of the substrate layer.

8. The display device of claim 1, wherein the dielectric layer is configured to have a plurality of arcuate concave surfaces disposed at predetermined locations adjacent to the one face of the substrate layer.

9. The display device of claim 8, wherein the dielectric layer is configured to have a plurality of arcuate recesses disposed at predetermined locations adjacent to the one face of the substrate layer.

10. The display device of claim 2, wherein the first electrode layer and the emitting layer allow light to pass through, and wherein the second electrode layer comprises a light reflective electrode layer.

11. The display device of claim 2, wherein the emitting layer and the second electrode layer allow light to pass through, and wherein the first electrode layer comprises a light reflective electrode layer.
